(19) United States
(12) Patent Application Publication
(10) Pub. No.: US 2026/0011473 A1
(43) Pub. Date: Jan. 8, 2026

(54) MAGNETIC POWDER, MAGNET, METHOD FOR PRODUCING MAGNETIC POWDER, AND METHOD FOR PRODUCING MAGNET

(71) Applicant: Murata Manufacturing Co, Ltd., Nagaokakyo-shi (JP)

(72) Inventors: Kazuki SATO, Nagaokakyo-shi (JP); Kazuhiro Takayama, Nagaokakyo-shi (JP); Satoshi Oga, Nagaokakyo-shi (JP)

(21) Appl. No.: 19/322,890

(22) Filed: Sep. 9, 2025

Related U.S. Application Data
(63) Continuation of application No. PCT/JP2023/043162, filed on Dec. 1, 2023.

(30) Foreign Application Priority Data
Mar. 28, 2023 (JP) 2023-051971

(51) Int. Cl. H01F 1/059; B22F 1/10; B22F 1/142; B22F 1/145; B22F 3/02; B22F 9/00; B22F 9/04; C22C 38/00; C22C 38/02; C22C 38/04; C22C 38/10; C22C 38/12; C22C 38/14; C22C 38/18; C23C 8/26; C23C 8/80; H01F 7/02; H01F 41/02

(52) U.S. Cl. CPC H01F 1/059; B22F 1/10; B22F 1/142; B22F 1/145; B22F 3/02; B22F 9/008; B22F 9/04; C22C 38/001; C22C 38/002; C22C 38/005; C22C 38/02; C22C 38/04; C22C 38/10; C22C 38/12; C22C 38/14; C22C 38/18; C23C 8/26; C23C 8/80; H01F 7/02; H01F 41/0266; B22F 2201/013; B22F 2201/016; B22F 2201/11; B22F 2301/355; B22F 2998/10; B22F 2999/00; C22C 2202/02

(57) ABSTRACT

A Sm—Fe—N-based magnetic material that includes: a main phase including a plurality of Sm—Fe—N-based crystal grains; and a grain boundary phase present between adjacent Sm—Fe—N-based crystal grains of the plurality of Sm—Fe—N-based crystal grains, and the grain boundary phase contains N, in which a ratio of a first content of N in the main phase to a second content of N in the grain boundary phase is 0.84 or more on an atomic basis.

### CROSS REFERENCE TO RELATED APPLICATIONS

The present application is a continuation of International application No. PCT/JP2023/043162, filed Dec. 1, 2023, which claims priority to Japanese Patent Application No. 2023-051971, filed Mar. 28, 2023, the entire contents of each of which are incorporated herein by reference.

### TECHNICAL FIELD

The present disclosure relates to a magnetic powder, a magnet, a method for producing a magnetic powder, and a method for producing a magnet.

### BACKGROUND ART

Rare earth magnets have high magnetic flux density and may be extremely strong permanent magnets, and are used for various applications. As one type of rare earth magnets, Sm—Fe—N-based magnets are known. The Sm—Fe—N-based magnet is typically produced by subjecting the Sm—Fe-based polycrystal to a nitriding treatment. It is considered that N atoms are dissolved in solid solution in the crystal lattice of the Sm—Fe-based polycrystal, thereby distorting the lattice and developing uniaxial magnetic anisotropy, and the resulting Sm—Fe—N-based magnetic material may function as a hard magnetic material.

As such a Sm—Fe—N-based magnetic material, Patent Document 1 describes that a flaky isotropic Sm—Fe—N-based powder magnet material is produced by nitriding a powder of a magnet alloy obtained by rapid cooling using rolls, and has a composition including SmₓFe₁₀₀₋ₓ₋ᵥNᵥ (wherein 7≤x≤12 and 0.5≤v≤20) in atom % and has a TbCu type crystal structure, and the thickness of the flake is 10 to 30 μm.

Patent Document 2 describes, as a Sm—Fe—N-based magnetic material, a rare earth permanent magnet material in which a composition component represented by atomic percent is represented by SmₓRaFe_{100-x-y-z-a}M_{y}N_{z} (wherein R is at least one of Zr and Hf, M is at least one of Co, Ti, Nb, Cr, V, Mo, Si, Ga, Ni, Mn, and Al, x+a is 7% to 10%, a is 0% to 1.5%, y is 0% to 5%, and z is 10% to 14%).
Patent Document 1: Japanese Patent Application Laid-Open No. 2002-57017
Patent Document 2: Japanese Patent Application Laid-Open No. 2018-157197

### SUMMARY OF THE DISCLOSURE

Both of the Sm—Fe—N-based magnetic materials described in Patent Documents 1 and 2 are produced without further heat treatment after performing a nitriding treatment. According to the study of the present inventors, the Sm—Fe—N-based magnetic materials described in Patent Documents 1 and 2 have insufficient coercive force, and in particular, in applications requiring heat resistance, the Sm—Fe—N-based magnetic materials are demagnetized, and thus cannot exhibit sufficient characteristics. Examples of applications requiring heat resistance include in-vehicle applications, and for example, heat resistance for 120° C. or more may be required.

An object of the present disclosure is to provide a Sm—Fe—N-based magnetic material having a favorable coercive force. In addition, an object of the present disclosure is to provide a method for producing such a Sm—Fe—N-based magnetic material.

The Sm—Fe—N-based magnetic material of the present disclosure includes: a main phase including a plurality of Sm—Fe—N-based crystal grains; and a grain boundary phase present between adjacent Sm—Fe—N-based crystal grains of the plurality of Sm—Fe—N-based crystal grains, and the grain boundary phase contains N, in which a ratio of a first content of N in the main phase to a second content of N in the grain boundary phase is 0.84 or more on an atomic basis.

The present disclosure can provide a Sm—Fe—N-based magnetic material having a favorable coercive force. In addition, the present disclosure can provide a method for producing such a Sm—Fe—N-based magnetic material.

### BRIEF EXPLANATION OF THE DRAWINGS

FIG. 1 shows a STEM-EDX analysis result of the Sm—Fe—N-based magnetic material obtained in Example 1, DF-I is a dark field image, and N is a mapping image (element distribution image) representing the concentration distribution of N atoms.

FIG. 2 shows a STEM-EDX analysis result of the Sm—Fe—N-based magnetic material obtained in Comparative Example 1, DF-I is a dark field image, and N is a mapping image (element distribution image) representing the concentration distribution of N atoms.

FIG. 3 shows a line profile of a concentration distribution of N atoms corresponding to an arrow in FIG. 1 in the Sm—Fe—N-based magnetic material obtained in Example 1.

FIG. 4 shows a line profile of a concentration distribution of N atoms corresponding to an arrow in FIG. 2 in the Sm—Fe—N-based magnetic material obtained in Comparative Example 1.

### DESCRIPTION OF THE PREFERRED EMBODIMENTS

### Embodiment 1: Sm—Fe—N-Based Magnetic Material

Hereinafter, the Sm—Fe—N-based magnetic material in one embodiment of the present disclosure will be described in detail, but the present disclosure is not limited to such an embodiment.

The Sm—Fe—N-based magnetic material of the present disclosure includes: a main phase including a plurality of Sm—Fe—N-based crystal grains; and a grain boundary phase that is present between adjacent Sm—Fe—N-based crystal grains of the plurality of Sm—Fe—N-based crystal grains, and the grain boundary phase contains N, in which a ratio of a first content of N in the main phase to a second content of N in the grain boundary phase is 0.84 or more on an atomic basis.

The Sm—Fe—N-based magnetic material of the present disclosure has the above configuration, and thus is favorable in the coercive force. Although it should not be construed as being limited to a specific theory, the reason why the Sm—Fe—N-based magnetic material of the present disclosure exhibits the above effect is considered as follows.

That is, it is considered that in the Sm—Fe—N-based magnetic material, N atoms form a solid solution in the crystal lattice of the Sm—Fe-based polycrystal, and thus the lattice is distorted and uniaxial magnetic anisotropy is developed. In the conventional Sm—Fe—N-based magnetic material, N atoms are preferentially distributed in the grain boundary phase, and the distribution to the main phase is limited, and thus it is considered that the effect of improving the magnetic anisotropy does not necessarily reflect the content of N. In contrast, in the Sm—Fe—N-based magnetic material of the present disclosure, the ratio of the content of N in the main phase to the content of N in the grain boundary phase is increased, and thus it is considered that the effect of improving the magnetic anisotropy is exhibited and the coercive force of the magnetic material is improved.

The ratio of the content of N in the main phase to the content of N in the grain boundary phase is 0.84 or more, preferably 0.85 or more on an atomic basis, and may be, for example, less than 1 and 0.99 or less. The ratio of the N content in such a range allows the coercive force of the Sm—Fe—N-based magnetic material to be improved.

In the present disclosure, the contents of N in the main phase and the grain boundary phase can be measured by energy dispersive X-ray analysis (STEM-EDX) using a scanning transmission electron microscope. For example, in a Sm—Fe—N-based magnetic material, an element distribution diagram is acquired in a field of view including a plurality of main phases and grain boundary phases. Then, in a dark field image of STEM or the like, a portion is selected where a phase considered to be a grain boundary formed between crystal grains is oriented in parallel to the electron beam incident direction, and a line profile indicating the content of N atoms is extracted with a direction orthogonal to the grain boundary phase as a scanning direction. Then, the content of N is measured with a position where the content of N is at a peak as a center, a region of 1 nm (2 nm in total) at a front and back of the center as a grain boundary phase, and the other region as a main phase, along the scanning direction. From the field of view of the field of view (for example, 522×522 nm²) in which 50 or more crystal grains of the main phase are present, such measurement is performed at three or more different points, and the content of N in the region corresponding to the main phase or the grain boundary phase is number-averaged based on the content of N at each measurement point, thereby providing the content of N in each phase. The content of N in the main phase is divided by the content of N in the grain boundary phase to calculate the ratio of the content of N in the main phase to the content of N in the grain boundary phase. The sample for STEM-EDX analysis of the Sm—Fe—N-based magnetic material may be processed by, for example, a focused ion beam apparatus (FIB).

The method for determining the content of N in the main phase and the grain boundary phase is not limited to the above. Instead of extracting the line profile from the element distribution diagram, the line profile may be obtained by scanning an electron beam perpendicularly to a grain boundary, or another method may be used as long as the spatial resolution and the detection accuracy satisfy the object, such as electron energy loss spectroscopy (TEM-EELS) using a transmission electron microscope, electron energy loss spectroscopy (STEM-EELS) using a scanning transmission electron microscope, or a three-dimensional atom probe (3DAP). As a method for obtaining the content of N in the main phase and the grain boundary phase, energy dispersive X-ray analysis (STEM-EDX) using a scanning transmission electron microscope is preferable in consideration of spatial resolution, detection sensitivity, quantitative accuracy, the size of an analyzable region, versatility, and the like.

In the Sm—Fe—N-based magnetic material, the Sm content is preferably 7.0 atom % to 11.5 atom %, and more preferably 7.0 atom % to 11.2 atom %, in a total of 100 atom % of the elements included in the Sm—Fe—N-based magnetic material. The Sm content in the Sm—Fe—N-based magnetic powder is in such a range, thereby allowing the coercive force of the Sm—Fe—N-based magnetic material to be further favorable.

In the Sm—Fe—N-based magnetic material, the content of Fe is preferably 61.5 atom % to 78.5 atom %, more preferably 61.6 atom % to 78.0 atom %, and still more preferably 61.6 atom % to 74.0 atom %, in a total of 100 atom % of the elements included in the Sm—Fe—N-based magnetic material. The Fe content in the Sm—Fe—N-based magnetic powder is in such a range, thereby allowing the coercive force of the Sm—Fe—N-based magnetic material to be favorable.

In the Sm—Fe—N-based magnetic material, the ratio of the Fe content to the Sm content (Fe content/Sm content) is preferably 5 to 11, more preferably 7 to 10, and still more preferably 8 to 9 on an atomic basis. The ratio of the Fe content to the Sm content in the Sm—Fe—N-based magnetic material is in such a range, thereby allowing the coercive force of the Sm—Fe—N-based magnetic material to be favorable.

In the Sm—Fe—N-based magnetic material, the total content of Sm and Fe is preferably 66.5 atom % to 90.0 atom %, more preferably 68.5 atom % to 88.0 atom %, and still more preferably 70.0 atom % to 86.0 atom %, in 100 atom % of the total of the Sm—Fe—N-based magnetic powder. The total content of Sm and Fe in the Sm—Fe—N-based magnetic material is in such a range, thereby allowing the coercive force of the Sm—Fe—N-based magnetic material to be favorable.

In the Sm—Fe—N-based magnetic material, the content of N is preferably 12.0 atom % to 18.0 atom %, and more preferably 12.5 atom % to 18.0 atom %, in a total of 100 atom % of the elements included in the Sm—Fe—N-based magnetic material. The content of N in the Sm—Fe—N-based magnetic material is in such a range, thereby allowing the coercive force of the Sm—Fe—N-based magnetic material to be favorable.

The Sm—Fe—N-based magnetic material may further include Co. In the Sm—Fe—N-based magnetic powder, the Co content is preferably 0.0 atom % to 9.0 atom %, in an aspect, more preferably 1.0 atom % to 9.0 atom %, and still more preferably 1.5 atom % to 8.7 atom %, in a total of 100 atom % of the elements included in the main phase. The content of Co in the Sm—Fe—N-based magnetic material is in the above range, thereby allowing the coercive force of the Sm—Fe—N-based magnetic material to be favorable. In another aspect, the content of Co in the Sm—Fe—N-based magnetic material is more preferably 0.0 atom % to 1.0 atom %, and still more preferably 0.0 atom % to 0.5 atom %. The content of Co in the Sm—Fe—N-based magnetic material is in the above range, thereby allowing the coercive force of the Sm—Fe—N-based magnetic material to be favorable.

The Sm—Fe—N-based magnetic material may further include M1 that is one or more elements selected from Ti, V, Cr, Mn, Zr, Nb, Hf, Ta, and Si. M1 can be preferably one or more selected from Zr and Nb.

In the Sm—Fe—N-based magnetic powder, the content of M1 is preferably 1.0 atom % to 4.0 atom %, more preferably 1.1 atom % to 4.0 atom %, and still more preferably 1.2 atom % to 4.0 atom %, in a total of 100 atom % of the elements included in the Sm—Fe—N-based magnetic material. The content of M1 in the Sm—Fe—N-based magnetic material is in the above range, thereby allowing the coercive force of the Sm—Fe—N-based magnetic material to be favorable.

The Sm—Fe—N-based magnetic material may further include M2 that is one or more elements selected from B and C. In the Sm—Fe—N-based magnetic powder, the content of M2 is preferably 0.0 atom % to 2.5 atom %, more preferably 0.1 atom % to 2.3 atom %, and still more preferably 0.1 atom % to 2.2 atom %, in a total of 100 atom % of the elements included in the Sm—Fe—N-based magnetic material. The content of M2 in the Sm—Fe—N-based magnetic material is in the above range, thereby allowing the coercive force of the Sm—Fe—N-based magnetic material to be favorable.

The Sm—Fe—N-based magnetic material may include O and/or Al as inevitable impurities. When the Sm—Fe—N-based magnetic material includes 0, the content of 0 may be, for example, 10.0 atom % or less, and further 5.0 atom % or less, in a total of 100 atom % of the elements included in the Sm—Fe—N-based magnetic material. In addition, when the Sm—Fe—N-based magnetic material includes Al, the content of Al can be, for example, 10.0 atom % or less, and further 5.0 atom % or less, in a total of 100 atom % of the elements included in the Sm—Fe—N-based magnetic material.

The content of each element in the Sm—Fe—N-based magnetic material does not exceed 100 atom % in total. The total content of all elements that may be included in the Sm—Fe—N-based magnetic material is theoretically 100 atom %.

In the present disclosure, the types and contents of elements other than C, N, and O that can be included in the Sm—Fe—N-based magnetic material can be measured by fluorescent X-ray analysis (XRF) or inductively coupled plasma atomic emission spectrometry (ICP-AES), and preferably can be measured by fluorescent X-ray analysis (XFR). In addition, C can be measured by a combustion-infrared absorption method in an oxygen stream, and N and O can be measured by an inert gas fusion-thermal conductivity method (TCD).

### (Main Phase)

The main phase includes Sm—Fe—N-based crystal grains. The Sm—Fe—N-based crystal grains have a structure in which N atoms are dissolved in solid solution in a crystal lattice of the Sm—Fe-based crystal. The main phase is a region that may contribute to exhibition of magnetism in the Sm—Fe—N-based magnetic material, and distortion is applied to the crystal lattice due to solid solution of N atoms, uniaxial magnetic anisotropy is developed, and the main phase may act as a hard magnetic material.

The main phase preferably includes one or more types selected from a Sm—Fe—N-based crystal exhibiting a Th₂Zn₁₇ type structure and a Sm—Fe—N-based crystal exhibiting a TbCu₇ type structure.

The main phase includes at least Sm, Fe, and N.

The content of N in the main phase is preferably 5.5 atom % to 6.3 atom %, more preferably 5.6 atom % to 6.2 atom %, still more preferably 5.7 atom % to 6.3 atom %, in a total of 100 atom % of the elements included in the main phase. The content of N in the main phase is in such a range, thereby enhancing the magnetic anisotropy, and allowing the coercive force of the Sm—Fe—N-based magnetic material to be favorable.

In the present disclosure, the contents of N in the main phase can be measured by energy dispersive X-ray analysis (STEM-EDX) using a scanning transmission electron microscope. For example, in a Sm—Fe—N-based magnetic material, an element distribution diagram is acquired in a field of view including a plurality of main phases and grain boundary phases. Then, in a dark field image of STEM or the like, a portion is selected where a phase considered to be a grain boundary phase formed between crystal grains is oriented in parallel to the electron beam incident direction, and a line profile indicating the content of N atoms is extracted with a direction orthogonal to the grain boundary phase as a scanning direction. Then, with the position where the N content is at the peak as the center, a region of 1 nm at the front and back (2 nm in total) along the scanning direction is defined as a grain boundary phase, and the N content is measured. From the field of view of the field of view (for example, 522×522 nm²) in which 50 or more crystal grains of the main phase are present, such measurement is performed at three or more different points, and the N content in the region corresponding to the main phase is number-averaged based on the content of N at each measurement point, thereby providing the content of N in the main phase. The observation surface of the Sm—Fe—N-based magnetic material may be formed by, for example, a focused ion beam device (FIB).

The main phase may further include Co.

The main phase may further include M1 that is one or more elements selected from Ti, V, Cr, Mn, Zr, Nb, Hf, Ta, and Si. M1 can be preferably one or more elements selected from Zr and Nb.

In addition, the main phase may further include M2 that is one or more elements selected from B and C.

The crystallite diameter of the Sm—Fe—N-based crystal grain included in the main phase is preferably 10 nm to 1 μm, more preferably 15 nm to 400 nm, and still more preferably 20 nm to 200 nm. The crystallite diameter of the Sm—Fe—N-based crystal grains is in the above range, thereby allowing the coercive force of the Sm—Fe—N-based magnetic material to be favorable. The Sm—Fe—N-based crystal grains may typically exist as a single crystal. In the present disclosure, the crystallite diameter can be directly measured from an image of a transmission electron microscope (TEM) or a scanning transmission electron microscope (STEM).

### (Grain Boundary Phase)

The grain boundary phase exists between the plurality of Sm—Fe—N-based crystal grains constituting the main phase. The grain boundary phase may typically be a layer covering the Sm—Fe—N-based crystal grains, and may exist, for example, as a continuous layer separating the plurality of Sm—Fe—N-based crystal grains. The grain boundary phase may be typically a nonmagnetic phase. The grain boundary phase is a nonmagnetic phase, whereby the magnetic domain of the main phase is divided by the grain boundary phase, and thus magnetic field inversion is suppressed and the coercive force can be increased.

The grain boundary phase includes N. In the grain boundary phase, the content of N is preferably 6.0 atom % to 7.5 atom, more preferably 6.3 atom % to 7.3 atom %, and still more preferably 6.5 atom % to 7.1 atom %, in a total of 100 atom % of the main phase. The content of N in the grain boundary phase is in such a range, thereby enhancing the magnetic anisotropy, and allowing the coercive force of the Sm—Fe—N-based magnetic material to be favorable.

In the present disclosure, the contents of N in the grain boundary phase can be measured by energy dispersive X-ray analysis (STEM-EDX) using a scanning transmission electron microscope. For example, in a Sm—Fe—N-based magnetic material, an element distribution diagram is acquired in a field of view including a plurality of main phases and grain boundary phases. Then, in a dark field image of STEM or the like, a portion is selected where a phase considered to be a grain boundary phase formed between crystal grains is oriented in parallel to the electron beam incident direction, and a line profile indicating the content of N atoms is extracted with a direction orthogonal to the grain boundary phase as a scanning direction. Then, with the position where the N content is at the peak as the center, a region of 1 nm at the front and back (2 nm in total) along the scanning direction is defined as a grain boundary phase, and the N content is measured. From the field of view of the field of view (for example, 522×522 nm²) in which 50 or more crystal grains of the main phase are present, such measurement is performed at three or more different points, and the N content in the region corresponding to the grain boundary phase is number-averaged based on the content of N at each measurement point, thereby providing the content of N in the grain boundary phase. The observation surface of the Sm—Fe—N-based magnetic material may be formed by, for example, a focused ion beam device (FIB).

The grain boundary phase may further include one or more types of elements selected from Sm, Fe, Co, Ti, V, Mn, Zr, Nb, Hf, Ta, Si, B, and C.

In another aspect, the grain boundary phase may be a region in which a measurement value having a higher N content than that of the Sm—Fe—N-based crystal grain phase is continuously measured by 2 nm or more in STEM-EDX analysis. In such an aspect, the thickness of the grain boundary phase is preferably 2 nm to 8 nm, and more preferably 4 nm to 6 nm. The width of the grain boundary phase is in such a range, thereby allowing the coercive force of the Sm—Fe—N-based crystal material to be favorable.

The Sm—Fe—N-based magnetic material of the present disclosure may include other different phases in addition to the main phase and the grain boundary phase. The Sm—Fe—N-based magnetic material can be a powder material including the main phase, the grain boundary phase, and a different phase that can be optionally included, and preferably can be a powder material including the main phase, the grain boundary phase, and a different phase that can be optionally included.

The Sm—Fe—N-based magnetic material of the present disclosure may be in the form of a magnetic powder, a magnet, or the like.

### (Sm—Fe—N-Based Magnetic Powder)

The Sm—Fe—N-based magnetic material may be in the form of magnetic powder (that is, powder). Hereinafter, the Sm—Fe—N-based magnetic material in the form of powder is also referred to as “Sm—Fe—N-based magnetic powder”.

The Sm—Fe—N-based magnetic powder can be a powder material including the main phase, the grain boundary phase, and a different phase that can be optionally included, and preferably can be a powder material including the main phase, the grain boundary phase, and a different phase that can be optionally included. The Sm—Fe—N-based magnetic powder includes Sm, Fe, and N.

The average particle diameter of the Sm—Fe—N-based magnetic powder may be preferably 10 μm to 300 μm, more preferably 10 μm to 50 μm, and still more preferably 20 μm to 40 μm.

The average particle diameter of the Sm—Fe—N-based magnetic powder can be measured by a laser diffraction particle size distribution measurement method.

### (Sm—Fe—N-Based Magnet)

The Sm—Fe—N-based magnetic material may be in the form of a magnet (that is, bulk). Hereinafter, the Sm—Fe—N-based magnetic material in the form of a bulk is also referred to as “Sm—Fe—N-based magnet”.

In one aspect, the Sm—Fe—N-based magnet preferably includes the Sm—Fe—N-based magnetic powder and a binder. The binder may act as a binder of the Sm—FeN-based magnetic powder, and typically may include a resin (plastic), rubber, or a metal such as Zn.

In such an aspect, the content of the Sm—Fe—N-based magnetic powder included in the Sm—FeN-based magnet may be preferably 90 mass % to 99.5 mass %, and more preferably 95 mass % to 99 mass %.

In such an aspect, examples of the resin include thermosetting resins such as an epoxy resin, a phenol resin, an allyl resin, and an unsaturated polyester resin; and thermoplastic resins such as a polyamide resin, a polyphenylene sulfide resin, a polyether ketone resin, a polyether ether ketone resin, and a polyester resin.

In such an aspect, the Sm—Fe—N-based magnet may include other additives in addition to the Sm—Fe—N-based magnetic powder and the resin.

In another aspect, the Sm—Fe—N-based magnet may be preferably a bulk magnet material including the main phase, the grain boundary phase, and a heterogeneous phase that may be optionally included, and may be preferably a bulk magnet material including the main phase, the grain boundary phase, and a heterogeneous phase that may be optionally included.

### Embodiment 2: Method for Producing Sm—Fe—N-Based Magnetic Material

The Sm—Fe—N-based magnetic material of the present disclosure may be produced by the production method including:
(a) preparing a Sm—Fe-based crystalline material;
(b) subjecting the Sm—Fe-based crystalline material to a nitriding treatment to produce a Sm—Fe—N-based precursor material; and
(c) heat-treating the Sm—Fe—N-based precursor material at 400° C. to 500° C. in an atmosphere in which the concentration of N atoms and the concentration of O atoms are each 100 ppm or less to produce a Sm—Fe—N-based magnetic material.

The production method of the present disclosure can provide a Sm—Fe—N-based magnetic material having a favorable coercive force. Although it should not be construed as being limited to a specific theory, the reason why the production method of the present disclosure exhibits the above effect is considered as follows.

As described above, in the Sm—Fe—N-based magnetic material, it is considered that N atoms are dissolved in solid solution in the crystal lattice of the Sm—Fe-based crystalline material, thereby distorting the lattice and developing uniaxial magnetic anisotropy. A conventional Sm—Fe—N-based magnetic material is produced by subjecting a Sm—Fe-based crystalline material to a nitriding treatment, but in such a nitriding treatment, a solid solution of N atoms in a crystal portion is limited, and the N atoms are mainly distributed in a grain boundary portion. In contrast, it is considered that in the production method of the present disclosure, the heat treatment is further performed in an atmosphere in which the concentration of N atoms and the concentration of O atoms are each 100 ppm or less after the nitriding treatment, and thus the solid solution of N atoms into the main phase may be promoted, and at the same time, the discharge of N atoms from the magnetic material is also suppressed, and as a result, a magnetic material having a high coercive force can be produced.

### (a) Preparation of Sm—Fe—N-Based Crystalline Material

In the production method of the present disclosure, first, a Sm—Fe—N-based crystalline material is prepared. The Sm—Fe—N-based crystalline material is typically preferably produced by a production method including: (i) preparing a Sm—Fe-based alloy including an amorphous phase; and (ii) subjecting the Sm—Fe-based alloy including the amorphous phase to a crystallization treatment, and pulverizing as necessary to provide a Sm—Fe-based crystalline material.

### (i) Preparation of Sm—Fe-Based Alloy Including Amorphous Phase

The preparation of the Sm—Fe-based alloy is preferably performed by a production method including: preparing a metal raw material including at least Sm and Fe; and melting, rapidly cooling, and solidifying the metal raw material to provide a Sm—Fe-based alloy.

The type and ratio of the elements included in the metal raw material have the same meaning as the type and ratio of the elements constituting the Sm—Fe—N-based magnetic material.

Melting the metal raw material may cause each element to be uniformly distributed in the melt. The temperature at which the metal is melted is preferably, for example, 1200° C. to 1700° C. The atmosphere for melting the metal is preferably an inert atmosphere including no nitrogen, such as an Ar atmosphere or a He atmosphere. Such melting is not particularly limited, but is preferably performed by high-frequency melting. The metal raw materials may be mixed before the metal raw materials are melted.

Rapidly cooling the melt may cause the melt to be cooled to a temperature equal to or less than a solidification point while maintaining uniformity of composition without being crystallized, and a Sm—Fe-based alloy including the amorphous phase is obtained.

The rapid cooling is not particularly limited, but is preferably performed by roll rapid cooling. In the roll rapid cooling, the melt is rapidly cooled by injecting the melt onto a rotating metal roll. The conditions for roll rapid cooling are not particularly limited. As the metal roll, for example, it is preferable to use a roll made of molybdenum, copper, or an alloy material containing these as a main component. The peripheral speed of the roll may be, for example, preferably 30 m/s to 100 m/s, and more preferably 50 m/s to 90 m/s.

### (ii) Preparation of Sm—Fe-Based Crystalline Material

Subjecting the Sm—Fe-based alloy including the amorphous phase to a crystallization treatment causes Sm—Fe—based crystals to be precipitated and a Sm—Fe-based crystalline material to be obtained. The crystallization treatment may be typically performed by heating.

The temperature in heating the Sm—Fe-based alloy including the amorphous phase may be, for example, preferably 690° C. to 800° C., and more preferably 725° C. to 785° C. The heating time for heating the Sm—Fe-based alloy including the amorphous phase is, for example, 5 minutes to 60 minutes, and preferably 5 minutes to 30 minutes. The atmosphere for heating the Sm—Fe-based alloy including the amorphous phase may be, for example, an inert atmosphere containing no nitrogen, such as an Ar atmosphere or a He atmosphere. Heating the Sm—Fe-based alloy including the amorphous phase under such conditions causes the Sm—Fe-based crystal to be easily generated more homogeneously.

The Sm—Fe-based crystalline material may be further pulverized. By pulverization, a powdery Sm—Fe-based crystalline material is obtained. The pulverization is not particularly limited, but can be performed by, for example, a crusher, a stamp mill, or a ball mill. By such pulverization, the Sm—Fe-based crystalline material is pulverized to, for example, 10 to 300 μm, preferably 10 to 150 μm, and more preferably 30 to 80 μm.

### (b) Nitriding Treatment of Sm—Fe-Based Crystalline Material

Subjecting the Sm—Fe-based crystalline material to a nitriding treatment causes N atoms to be incorporated into the Sm—Fe-based crystalline material, thereby allowing a Sm—Fe—N-based precursor material to be obtained.

The nitriding treatment may be typically performed by performing a heat treatment in a nitrogen atmosphere, an ammonia atmosphere, a hydrogen atmosphere, or a mixed atmosphere thereof.

When nitrogen gas is used in the nitriding treatment, the partial pressure of nitrogen is 10 kPa to 100 kPa, preferably 50 kPa to 100 kPa. Using such a nitrogen partial pressure sufficiently proceeds the nitriding reaction.

When a mixed gas of ammonia and hydrogen is used in the nitriding treatment, the partial pressure of ammonia is 20 kPa to 40 kPa, preferably 25 kPa to 33 kPa, where the total pressure of the mixed gas is 0.1 MPa. Using such an ammonia partial pressure sufficiently proceeds the nitriding reaction.

In the nitriding treatment, the heating temperature is preferably 350° C. to 500° C., and more preferably 400° C. to 500° C. Using this heating temperature can prevent the decomposition into SmN and Fe that may occur when the nitriding reaction is performed at a higher temperature, and can sufficiently progress the reaction as compared with the case where the nitriding reaction is performed at a lower temperature.

Typically, the nitriding treatment may be performed under atmospheric pressure, and for example, may be performed under a pressure of preferably 900 hPa to 1100 hPa, and more preferably 950 hpa to 1050 hPa.

When nitrogen gas is used in the nitriding treatment, the heating time is preferably 2 hours to 30 hours, and more preferably 8 hours to 25 hours. Using this heating time can prevent grain growth and decomposition into SmN and Fe that may occur when the heating time is longer, and can more sufficiently proceed the reaction as compared with the case where the heating time is shorter. Adjusting the heating time allows the amount of nitrogen incorporated into the Sm—Fe-based crystalline material to be adjusted.

When a mixed gas of ammonia and hydrogen is used in the nitriding treatment, the heating time is preferably 10 minutes to 90 minutes, and more preferably 20 minutes to 60 minutes. Using this heating time can prevent grain growth and decomposition into SmN and Fe that may occur when the heating time is longer, and can more sufficiently proceed the reaction as compared with the case where the heating time is shorter. Adjusting the heating time allows the amount of nitrogen incorporated into the Sm—Fe-based crystalline material to be adjusted.

### (c) Heat Treatment of Sm—Fe—N-Based Precursor Material

Heat-treating the Sm—Fe—N-based precursor material at 400° C. to 500° C. in an atmosphere in which the concentration of N atoms and the concentration of O atoms are each 100 ppm or less causes N atoms to diffuse into the main phase, thereby providing the Sm—Fe—N-based magnetic material of the present disclosure. Hereinafter, the heat treatment of the Sm—Fe—N-based precursor material is also referred to as “continuous heat treatment”.

It is preferable that the step of cooling the Sm—Fe—N-based precursor material is not included between the nitriding treatment and the continuous heat treatment, and it is preferable that the continuous heat treatment is performed as it is following the nitriding treatment.

An atmosphere in which the concentration of N atoms and the concentration of O atoms are each 100 ppm or less in the continuous heat treatment is a H₂ gas atmosphere; Ar atmosphere; He atmosphere; and a mixed atmosphere of H₂ gas and Ar or He.

In the continuous heat treatment, the heating temperature is preferably 350° C. to 500° C., and more preferably 400° C. to 500° C. Using this heating temperature can prevent the decomposition into SmN and Fe that may occur when the heat treatment is performed at a higher temperature, and it is possible to sufficiently proceed the solid solution of the N atom in the main phase as compared with the case where the heat treatment is performed at a lower temperature.

Typically, the continuous heat treatment may be performed under atmospheric pressure, and for example, may be performed under a pressure of preferably 900 hPa to 1100 hPa, and more preferably 950 hPa to 1050 hPa.

In the continuous heat treatment, the heating time is preferably 30 minutes to 600 minutes, and more preferably 30 minutes to 240 minutes. Using this heating time can prevent grain growth and decomposition into SmN and Fe that may occur when the heating time is longer, and can sufficiently proceed solid solution of N atoms into the main phase as compared with the case where the heating time is shorter.

After the continuous heat treatment, natural cooling may be performed.

A powdery Sm—Fe—N-based magnetic material (i.e., Sm—Fe—N-based magnetic powder) is typically obtained by (a) the preparation of the Sm—Fe—N-based crystalline material, (b) the nitriding treatment of the Sm—Fe-based crystalline material, and (c) the heat treatment of the Sm—Fe—N-based precursor material.

In one aspect, the Sm—Fe—N-based magnet can be produced by a production method including mixing the Sm—Fe—N-based magnetic powder and a raw material of a binder to provide a mixture, and molding the mixture to provide the Sm—Fe—N-based magnet. Examples of the method for molding the mixture include compression molding and injection molding. For example, the method may be performed by heating and melting a resin raw material in a mixture or dissolving the resin raw material in a solvent to form a liquid, and subjecting the liquid mixture to compression molding and injection molding. The liquid mixture may be cured by cooling, crosslinking of a binder raw material, removal of a solvent, or the like. In addition, the Sm—Fe—N-based magnet may be produced by sintering the Sm—Fe—N-based magnetic powder.

The Sm—Fe—N-based magnetic material of the present disclosure has a favorable coercive force, and can be suitably used for various applications such as an electromagnetic actuator (motor). The Sm—Fe—N-based magnetic material of the present disclosure is less likely to be demagnetized at high temperatures, and thus can be suitably used in applications requiring reliability in a high-temperature environment such as in-vehicle applications.

### EXAMPLES

The present disclosure will be more specifically described with reference to the following examples, but the present disclosure is not limited thereto.

### Examples 1 to 19

Elements having compositions described in Table 1 were charged, and a mother alloy was prepared by high frequency melting. The obtained mother alloy was melted in an Ar atmosphere and injected onto a Mo roll rotating at a peripheral speed of 70 m/s to provide a rapidly cooled thin strip (Sm—Fe-based amorphous material). This rapidly cooled thin strip was heat-treated at a treatment temperature of 755° C. under an Ar gas atmosphere to provide a Sm—Fe-based crystalline material, which was then pulverized so as to pass through a mesh of 150 μm. The composition described in Table 1 is based on atomic percent.

Then, the heat-treated powder (powdered Sm—Fe-based crystalline material) was subjected to a nitriding treatment at the temperature described in Table 1 for the time described in Table 1 under the atmosphere described in Table 1 to provide a Sm—Fe—N-based precursor material. After the nitriding treatment, continuous heat treatment was continuously performed under the atmosphere described in Table 1 to provide a Sm—Fe—N-based magnetic material. The temperature and time of the continuous heat treatment were as shown in Table 1.

### Comparative Examples 1 to 4

Sm—Fe—N-based materials were obtained in the same manner as in Examples 1 to 19 except that the continuous heat treatment was not performed after the nitriding treatment in Comparative Examples 1 and 2.

In addition, the continuous heat treatment was performed for Comparative Examples 3 and 4, but the coercive force was lowered because the decomposition into SmN and Fe was partly deepened due to the high temperature of the continuous heat treatment.

TABLE 1

| | | | | M1 | | | | | | | | | M2 | | |
|---|---|---|---|---|---|---|---|---|---|---|---|---|---|---|---|
| | Sm | Fe | Co | Ti | V | Cr | Mn | Zr | Nb | Hf | Ta | Si | B | C | N |
| Example 1 | 8.5 | 72.4 | | | | | | 2.6 | | | | | | 0.5 | 16.0 |
| Example 2 | 9.2 | 75.6 | | 1.3 | | | | | | | | | | 0.9 | 13.0 |
| Example 3 | 9.8 | 74.4 | | | 1.3 | | | | | | | | | 0.9 | 13.6 |
| Example 4 | 9.8 | 73.4 | | | | 1.7 | | | | | | | | 0.9 | 14.2 |
| Example 5 | 8.9 | 73.8 | | | | | | | 2.6 | | | | | 0.9 | 13.8 |
| Example 6 | 8.3 | 71.0 | | | | | | 2.5 | | | | 0.8 | | 0.5 | 16.9 |
| Example 7 | 7.9 | 71.4 | | | | | | 2.1 | | | | | 0.7 | | 17.9 |
| Example 8 | 8.6 | 71.3 | | | | | | 3.4 | | | | | | 2.1 | 14.6 |
| Example 9 | 8.4 | 67.6 | 2.1 | | | | | 3.0 | | | | | | 1.3 | 17.6 |
| Example 10 | 9.0 | 69.6 | 4.3 | | | | | | 1.7 | | | | | 0.9 | 14.5 |
| Example 11 | 8.4 | 70.1 | | | | | 1.0 | 2.5 | | | | | | 1.0 | 17.0 |
| Example 12 | 7.7 | 70.3 | | | | | | 2.6 | 1.3 | | | | | 1.3 | 16.8 |
| Example 13 | 8.2 | 73.5 | | | | | | 1.3 | 1.3 | | | | | 0.5 | 15.2 |
| Example 14 | 8.4 | 69.4 | 1.7 | | | | | 1.3 | 1.3 | | | | | 0.9 | 17.0 |
| Example 15 | 9.3 | 71.1 | | | | | | | | 2.6 | | | | 0.9 | 16.1 |
| Example 16 | 9.5 | 73.2 | | | | | | | | | 2.6 | | | 0.9 | 13.8 |
| Example 17 | 7.8 | 78.1 | | | | | | 1.3 | | | | | | 0.6 | 12.2 |
| Example 18 | 7.0 | 73.4 | | | | | | 3.9 | | | | | | 0.2 | 15.5 |
| Example 19 | 11.1 | 61.6 | 8.6 | | | | | | 2.6 | | | | | 0.9 | 15.2 |
| Comp. | 8.3 | 70.9 | | | | | | 2.5 | | | | | | 0.5 | 17.8 |
| Example 1 | | | | | | | | | | | | | | | |
| Comp. | 9.6 | 62.1 | 6.0 | | | | | 2.6 | 1.3 | | | | | 0.9 | 17.5 |
| Example 2 | | | | | | | | | | | | | | | |
| Comp. | 8.8 | 72.3 | | | | | | 3.5 | | | | | | 2.1 | 13.3 |
| Example 3 | | | | | | | | | | | | | | | |
| Comp. | 9.0 | 69.4 | 4.3 | | | | | | 1.7 | | | | | 0.9 | 14.7 |
| Example 4 | | | | | | | | | | | | | | | |

| | Nitriding treatment | | | Continuous heat treatment | | |
|---|---|---|---|---|---|---|
| | | Temperature | Time | | Temperature | Time |
| | Atmosphere | (° C.) | (hr) | Atmosphere | (° C.) | (hr) |
| Example 1 | NH₃—H₂ (flow | 450 | 1.0 | H₂ | 450 | 1.0 |
| | ratio 1:2) | | | | | |
| Example 2 | NH₃—H₂ (flow | 450 | 1.0 | H₂ | 450 | 1.0 |
| | ratio 1:2) | | | | | |
| Example 3 | NH₃—H₂ (flow | 450 | 1.0 | H₂ | 450 | 1.0 |
| | ratio 1:2) | | | | | |
| Example 4 | NH₃—H₂ (flow | 450 | 1.0 | H₂ | 450 | 2.0 |
| | ratio 1:2) | | | | | |
| Example 5 | NH₃—H₂ (flow | 450 | 1.0 | H₂ | 450 | 1.0 |
| | ratio 1:2) | | | | | |
| Example 6 | NH₃—H₂ (flow | 450 | 1.0 | H₂ | 450 | 1.0 |
| | ratio 1:2) | | | | | |
| Example 7 | NH₃—H₂ (flow | 450 | 1.0 | H₂ | 450 | 1.0 |
| | ratio 1:2) | | | | | |
| Example 8 | NH₃—H₂ (flow | 450 | 1.0 | H₂ | 450 | 1.0 |
| | ratio 1:2) | | | | | |
| Example 9 | NH₃—H₂ (flow | 450 | 1.0 | H₂ | 450 | 1.0 |
| | ratio 1:2) | | | | | |
| Example 10 | NH₃—H₂ (flow | 450 | 1.0 | H₂ | 450 | 1.0 |
| | ratio 1:2) | | | | | |
| Example 11 | NH₃—H₂ (flow | 450 | 1.0 | H₂ | 450 | 1.0 |
| | ratio 1:2) | | | | | |
| Example 12 | NH₃—H₂ (flow | 450 | 1.0 | H₂ | 450 | 1.0 |
| | ratio 1:2) | | | | | |
| Example 13 | NH₃—H₂ (flow | 450 | 1.0 | H₂ | 450 | 1.0 |
| | ratio 1:2) | | | | | |
| Example 14 | NH₃—H₂ (flow | 450 | 1.0 | H₂ | 450 | 1.0 |
| | ratio 1:2) | | | | | |
| Example 15 | NH₃—H₂ (flow | 450 | 1.0 | H₂ | 450 | 2.0 |
| | ratio 1:2) | | | | | |
| Example 16 | NH₃—H₂ (flow | 450 | 1.0 | H₂ | 450 | 1.0 |
| | ratio 1:2) | | | | | |
| Example 17 | N₂ | 450 | 8.0 | Ar | 430 | 2.0 |
| Example 18 | N₂ | 450 | 8.0 | Ar | 430 | 4.0 |
| Example 19 | NH₃—H₂ (flow | 450 | 1.0 | H₂ | 450 | 1.0 |
| | ratio 1:2) | | | | | |
| Comp. | NH₃—H₂ (flow | 450 | 1.0 | — | — | — |
| Example 1 | ratio 1:2) | | | | | |
| Comp. | N₂ | 450 | 8.0 | — | — | — |
| Example 2 | | | | | | |
| Comp. | N₂ | 450 | 8.0 | Ar | 520 | 2.0 |
| Example 3 | | | | | | |
| Comp. | NH₃—H₂ (flow | 450 | 1.0 | H₂ | 520 | 1.0 |
| Example 4 | ratio 1:2) | | | | | |

### (STEM-EDX Analysis: Acquisition of Dark Field Image and Element Distribution Image)

The materials obtained in the above Examples and Comparative Examples were processed by a focused ion beam apparatus and an Ar milling apparatus, and an observation image (dark field image) by a transmission electron microscope (acceleration voltage 200 kV) equipped with a spherical aberration corrector manufactured by FEI and an element distribution view by energy dispersive X-ray analysis (EDX) were obtained. The visual field length of each image was 522 nm×522 nm, and the number of pixels at the time of EDX data collection was 512×512 px.

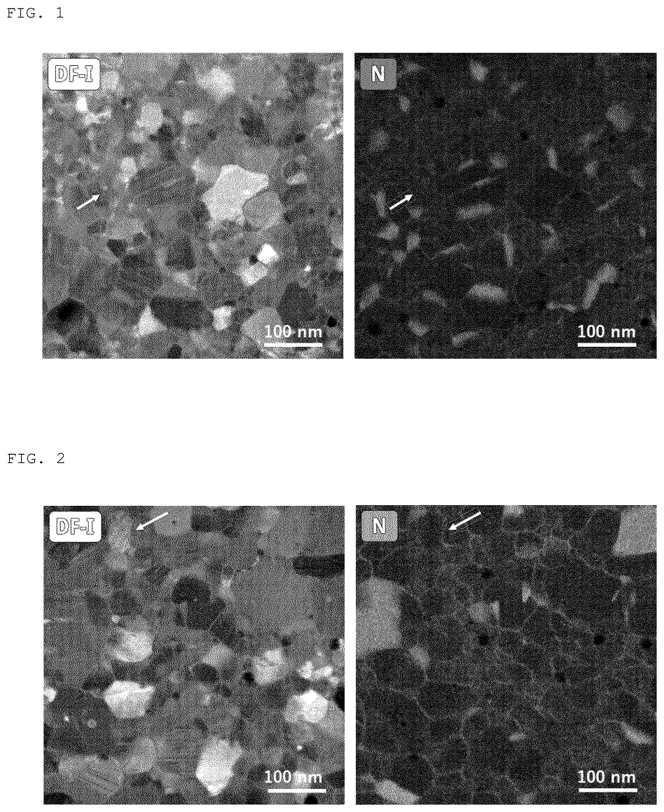

FIG. 1 shows the analysis results of the Sm—Fe—N-based magnetic material obtained in Example 1, and FIG. 2 shows the analysis results of the material obtained in Comparative Example 1. In FIGS. 1 and 2, an image indicated by DF-I indicates a dark field image by STEM, and an image indicated by N indicates an element distribution image of N atoms.

In the material of Comparative Example 1 shown in FIG. 2, when the STEM dark field image and the element distribution image of N atoms are compared, it has been confirmed that a region where the concentration of N atoms is high exists along the grain boundary, and N atoms are intensively distributed in the grain boundary phase portion. In contrast, in the Sm—Fe—N-based magnetic material of Example 1 shown in FIG. 1, the difference in N atom distribution between the grain boundary phase portion and the main phase portion is smaller than that in Comparative Example 1. This is considered to be because in Example 1, the continuous heat treatment was performed after the nitriding treatment, and as a result of performing such a treatment, the N atom contents of the main phase and the grain boundary phase approached a uniform value.

### (STEM-EDX Analysis: Acquisition of Line Profile)

From the element distribution view, a portion where a phase considered to be a grain boundary formed between crystal grains was oriented parallel to the electron beam incident direction was selected, and a line profile indicating the content of N atoms in a direction orthogonal to the grain boundary was extracted. In Example 1, the width of the region from which the line profile was extracted was 20 nm, the length was 41 nm, and the distance between extraction points was 1 nm, and in Comparative Example 1, the width of the region from which the line profile was extracted was 20 nm, the length was 61 nm, and the distance between extraction points was 1 nm. However, the region from which the line profile is extracted is not limited to the above range. In general, when the extraction width is narrow, the S/N ratio of the line profile is deteriorated, and when the extraction width is wide, orthogonality to a grain boundary having a curvature is deteriorated. In addition, the extraction length is too short, arising a concern that the information on the content of N in the main phase and the grain boundary phase is insufficient, and the extraction length is too long, arising a concern that information on a grain boundary phase different from that focused on affects the line profile. In consideration of these circumstances, it is desirable to adopt conditions suitable for the microstructure to be analyzed.

In the obtained line profile, a region of 1 nm (2 m in total) at the front and back of the center along the scanning direction around the position where the N atom content is at the peak was defined as a grain boundary phase, and the other region was defined as a main phase. Based on the N atom content at each measurement point, the N atom content in the main phase and the N atom content in the grain boundary phase were calculated. In each of Examples and Comparative Examples, the above measurement was performed three or more times, and the content of N atoms in the main phase and the content of N atoms in the grain boundary phase were averaged to determine the content of N atoms in the main phase or the grain boundary phase for each Example and Comparative Example. The content of N atoms in the main phase was divided by the content of N atoms in the grain boundary phase to calculate the ratio of the content of N atoms in the main phase to the content of N atoms in the grain boundary phase.

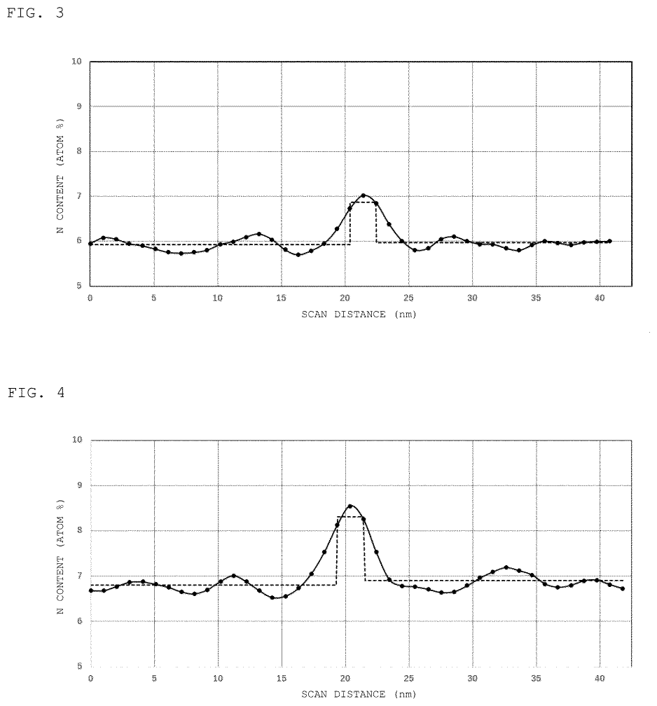

FIG. 3 is an example showing the content of N atoms with respect to the position where the line profile is extracted for the Sm—Fe—N-based magnetic material obtained in Example 1. The solid line shows a line profile indicating the content of N atoms extracted in the direction, width, and length indicated by the arrow in FIG. 1. The broken line indicates the average value of the contents of N atoms in the grain boundary phase and the main phase. The average value of the content of N atoms in the main phase is calculated independently for the left side and the right side of the grain boundary phase on the line profile. In the Sm—Fe—N-based magnetic material obtained in Example 1, the content of N atoms in the grain boundary phase was 6.86 atom %, the content of N atoms in the main phase was 5.92 atom % on the left side of the grain boundary phase and 5.96 atom % on the right side of the grain boundary phase on the line profile, and the average value as the entire grain boundary phase was 5.94 atom %. Therefore, in the Sm—Fe—N-based magnetic material obtained in Example 1, it can be said that the ratio of the content of N atoms in the main phase to the content of N atoms in the grain boundary phase is 0.87 on the left side of the main phase and 0.86 on the right side of the main phase on an atomic basis, and the average value of the entire main phase is 0.87.

FIG. 4 is an example showing the content of N atoms with respect to the position where the line profile is extracted for the material obtained in Comparative Example 1. The solid line shows a line profile indicating the content of N extracted in the direction, width, and length indicated by the arrow in FIG. 2. The broken line indicates the average value of the contents of N atoms in the grain boundary phase and the main phase. In the Sm—Fe—N-based magnetic material obtained in Comparative Example 1, the content of N atoms in the grain boundary phase was 8.31 atom %, the content of N atoms in the main phase was 6.71 atom % on the left side of the grain boundary phase and 6.90 atom % on the right side of the grain boundary phase on the line profile, and the average value as the entire grain boundary phase was 6.85 atom %. Therefore, in the Sm—Fe—N-based magnetic material obtained in Comparative Example 1, it can be said that the ratio of the content of N atoms in the main phase to the content of N atoms in the grain boundary phase is 0.81 on the left side of the grain boundary phase and 0.83 on the right side of the grain boundary phase on an atomic basis, and the average value as the entire main phase is 0.82.

### (Magnetic Measurement)

Magnetic measurement was performed using a VSM (vibrating sample magnetometer).

TABLE 2

| | Hcj (kA/m) |
|---|---|
| Example 1 | 1,500 |
| Example 2 | 1,960 |
| Example 3 | 1,600 |
| Example 4 | 1,400 |
| Example 5 | 2,250 |
| Example 6 | 1,370 |
| Example 7 | 1,230 |
| Example 8 | 1,700 |
| Example 9 | 1,380 |
| Example 10 | 1,620 |
| Example 11 | 1,320 |
| Example 12 | 1,400 |
| Example 13 | 1,630 |
| Example 14 | 1,500 |
| Example 15 | 1,590 |
| Example 16 | 1,690 |
| Example 17 | 1,270 |
| Example 18 | 1,500 |
| Example 19 | 1,500 |
| Comparative | 930 |
| Example 1 | |
| Comparative | 1,100 |
| Example 2 | |
| Comparative | 1,210 |
| Example 3 | |
| Comparative | 980 |
| Example 4 | |

It has been confirmed that the difference in N atom content between the grain boundary phase and the main phase was small in the Sm—Fe—N-based magnetic material of Examples as compared with the material of Comparative Examples. For example, in the Sm—Fe—N-based magnetic material of Example 1 shown in FIG. 3, the ratio of the content of N atoms in the main phase to the content of N atoms in the grain boundary phase is 0.86 or more, whereas in the material of Comparative Example 1 shown in FIG. 4, the ratio is 0.81. From this, it is confirmed that the distribution of N atoms in the main phase and the grain boundary phase becomes more uniform by performing the continuous heat treatment after the nitriding treatment.

From Examples and Comparative Examples, it has been confirmed that a Sm—Fe—N-based magnetic material having a high coercive force can be obtained by performing continuous heat treatment under an inert atmosphere including no N atoms after the nitriding treatment. For example, in Example 1, the coercive force is 1500 kA/m, and a high coercive force is obtained as compared with 930 kA/m in Comparative Example 1 in which the continuous heat treatment is not performed.

As described above, in Examples and Comparative Examples, although the constituent elements and compositions included in the materials are close to each other, a large difference may occur in the coercive force. This is considered to be because the continuous heat treatment after the nitriding treatment causes N atoms to be dissolved in solid solution into the main phase, and the main phase and the grain boundary phase are distributed so as to be more uniform.

The Sm—Fe—N-based magnetic material of the present disclosure is favorable in the coercive force, and can be suitably used for various applications.

1. A Sm—Fe—N-based magnetic material comprising:
a main phase including a plurality of Sm—Fe—N-based crystal grains; and
a grain boundary phase present between adjacent Sm—Fe—N-based crystal grains of the plurality of Sm—Fe—N-based crystal grains, and the grain boundary phase contains N, wherein
a ratio of a first content of N in the main phase to a second content of N in the grain boundary phase is 0.84 or more on an atomic basis.

2. The Sm—Fe—N-based magnetic material according to claim 1, wherein
a content of Sm is 7.0 atom % to 11.5 atom % in a total of 100 atom % of all elements included in the Sm—Fe—N-based magnetic material,
a content of Fe is 61.5 atom % to 78.5 atom % in the total of 100 atom % of all elements included in the Sm—Fe—N-based magnetic material,
a content of Co is 0 atom % to 9.0 atom % in a total of 100 atom % of the elements included in the main phase,
a content of M1 that is one or more elements selected from Ti, V, Cr, Mn, Zr, Nb, Hf, Ta, and Si is 1.0 atom % to 4.0 atom % in the total of 100 atom % of all elements included in the Sm—Fe—N-based magnetic material,
a content of M2 that is one or more elements selected from B and C is 0 atom % to 2.5 atom % in the total of 100 atom % of all elements included in the Sm—Fe—N-based magnetic material, and
a content of the N is 12.0 atom % to 18.0 atom % in the total of 100 atom % of all elements included in the Sm—Fe—N-based magnetic material.

3. The Sm—Fe—N-based magnetic material according to claim 1, wherein a ratio of a content of the Fe to a content of the Sm is 5 to 11 on an atomic basis.

4. The Sm—Fe—N-based magnetic material according to claim 1, wherein a total content of the Sm and the Fe is 66.5 atom % to 90.0 atom % in 100 atom % of a total of the Sm—Fe—N-based magnetic powder.

5. The Sm—Fe—N-based magnetic material according to claim 1, wherein a content of Co in the Sm—Fe—N-based magnetic material is 0.0 atom % to 1.0 atom % in a total of 100 atom % of all elements included in the Sm—Fe—N-based magnetic material.

6. The Sm—Fe—N-based magnetic material according to claim 1, wherein the plurality of Sm—Fe—N-based crystal grains in the main phase includes one or more types selected from a Sm—Fe—N-based crystal exhibiting a Th₂Zn₁₇ type structure and a Sm—Fe—N-based crystal exhibiting a TbCu₇ type structure.

7. The Sm—Fe—N-based magnetic material according to claim 1, wherein a content of N in the main phase is 5.5 atom % to 6.3 atom % in a total of 100 atom % of all elements included in the main phase.

8. The Sm—Fe—N-based magnetic material according to claim 1, wherein a crystallite diameter of the Sm—Fe—N-based crystal grain in the main phase is 10 nm to 1 μm.

9. The Sm—Fe—N-based magnetic material according to claim 1, wherein the grain boundary phase is a layer covering the Sm—Fe—N-based crystal grains.

10. The Sm—Fe—N-based magnetic material according to claim 1, wherein the grain boundary phase is a nonmagnetic phase.

11. The Sm—Fe—N-based magnetic material according to claim 1, wherein a content of N in the grain boundary phase is 6.0 atom % to 7.5 atom % in a total of 100 atom % of the main phase.

12. The Sm—Fe—N-based magnetic material according to claim 1, in a form of a magnetic powder or a magnet.

13. A Sm—Fe—N-based magnet comprising:
the Sm—Fe—N-based magnetic powder according to claim 3; and
a binder.

14. A method for producing a Sm—Fe—N-based magnetic material, the method comprising:
preparing a Sm—Fe-based crystalline material;
subjecting the Sm—Fe-based crystalline material to a nitriding treatment to produce a Sm—Fe—N-based precursor material; and
subjecting the Sm—Fe—N-based precursor material to a heat treatment at 400° C. to 500° C. in an atmosphere in which a concentration of N atoms and a concentration of 0 atoms are each 100 ppm or less, to produce the Sm—Fe—N-based magnetic material.

15. The method according to claim 14, wherein a step of cooling the Sm—Fe—N-based precursor material is not conducted between the nitriding treatment and the heat treatment.

16. The method according to claim 14, wherein, in the heat treatment, a heating time is 30 minutes to 600 minutes.

17. A method for producing a Sm—Fe—N-based magnet, the method further comprising:
preparing a Sm—Fe-based crystalline material;
subjecting the Sm—Fe-based crystalline material to a nitriding treatment to produce a Sm—Fe—N-based precursor material;
subjecting the Sm—Fe—N-based precursor material to a heat treatment at 400° C. to 500° C. in an atmosphere in which a concentration of N atoms and a concentration of 0 atoms are each 100 ppm or less, to produce a Sm—Fe—N-based magnetic powder;
mixing the Sm—Fe—N-based magnetic powder and a raw material of a binder to produce a mixture; and
molding the mixture to produce the Sm—Fe—N-based magnet.

18. The method according to claim 17, wherein a step of cooling the Sm—Fe—N-based precursor material is not conducted between the nitriding treatment and the heat treatment.

19. The method according to claim 17, wherein, in the heat treatment, a heating time is 30 minutes to 600 minutes.
